(19) United States
(12) Patent Application Publication
(10) Pub. No.: US 2026/0106462 A1
(43) Pub. Date: Apr. 16, 2026

(54) POWER OVER DATA LINE SYSTEM FOR SUPPLYING POWER AND AN OPERATION METHOD THEREFOR

(71) Applicants: HYUNDAI MOTOR COMPANY, Seoul (KR); KIA CORPORATION, Seoul (KR)

(72) Inventor: Soon Chul Park, Hwaseong-si (KR)

(73) Assignees: HYUNDAI MOTOR COMPANY, Seoul (KR); KIA CORPORATION, Seoul (KR)

(21) Appl. No.: 19/076,722

(22) Filed: Mar. 11, 2025

(30) Foreign Application Priority Data
Oct. 14, 2024 (KR) 10-2024-0139173

(51) Int. Cl. H02J 7/34; H04L 12/10

(52) U.S. Cl. CPC H02J 7/342; H04L 12/10; H02J 2207/10; H02J 2207/20

(57) ABSTRACT

A Power over Data Line (PoDL) system for supplying power includes a high-voltage battery. The system also includes a first controller comprising a first controller unit, a first power sourcing equipment (PSE) controller, a first powered device (PD) controller, a first power connector, a first Ethernet connector, and a first selector. The system also includes a second controller comprising a second controller unit, a second PSE controller, a second PD controller, a second power connector, a second Ethernet connector, and a second selector. The system also incudes a low-voltage battery connected to the first power connector. The system also includes a low voltage DC-DC converter (LDC) connected to the second power connector and the high-voltage battery in series. The first Ethernet connector and the second Ethernet connector are connected to each other via a wire.

### CROSS-REFERENCE TO RELATED APPLICATION

This application claims the benefit of and priority to Korean Patent Application No. 10-2024-0139173, filed on Oct. 14, 2024, the entire disclosures of which are incorporated herein by reference.

### TECHNICAL FIELD

The present disclosure relates to a Power over Data Line (PoDL) system for supplying power and a method of operating the same. More particularly, the present disclosure relates to a PoDL system and a method of operating the same, which charge a low-voltage battery from a high-voltage battery while supplying power to a controller in both directions using the high-voltage battery and the low-voltage battery.

### BACKGROUND

The content described hereinbelow merely provides background information on the present disclosure and does not constitute the prior art.

A method of transmitting power to power remote equipment using a data line is known. A Power over Data Line (PoDL) is an example of such a system. The PoDL may transmit data and power using the same line. The PoDL is used in various fields to minimize wiring and reduce costs.

Meanwhile, an Ethernet switch operating as a power sourcing equipment (PSE) may receive power from a low-voltage battery and then may supply power to a controller operating as a powered device (PD) through an Ethernet wire. It is necessary to charge the low voltage battery so as to continuously supply power to the controller. If an output terminal of a Low voltage DC-DC Converter (LDC) is connected to a controller that operates as the PD, the controller may receive power, but the low-voltage battery may not be charged because the controller may not supply power to the low-voltage battery.

Therefore, a technology is required that can charge a low-voltage battery from a high-voltage battery while supplying power to a controller in both directions using the high-voltage battery and the low-voltage battery.

### SUMMARY

In view of the above, an objective of the present disclosure is to provide a Power over Data Line (PoDL) system, which can charge a low-voltage battery from a high-voltage battery while supplying power to a controller in both directions using the high-voltage battery and the low-voltage battery.

The objectives to be achieved by the present disclosure are not limited to the above-mentioned objectives, and other objectives, which are not mentioned, should be clearly understood by those having ordinary skill in the art from the following description.

According to an embodiment of the present disclosure, a PoDL system for supplying power includes a high-voltage battery. The system also includes a first controller comprising a first controller unit, a first power sourcing equipment (PSE) controller, a first powered device (PD) controller, a first power connector, a first Ethernet connector, and a first selector. The system also includes a second controller comprising a second controller unit, a second PSE controller, a second PD controller, a second power connector, a second Ethernet connector, and a second selector. The system also includes a low-voltage battery connected to the first power connector. The system also includes a low voltage DC-DC converter (LDC) connected to the second power connector and the high-voltage battery in series. The first Ethernet connector and the second Ethernet connector are connected to each other via a wire.

According to another embodiment of the present disclosure, a method of operating a PoDL system includes comparing a voltage level of a first power connector of a first controller with a voltage level of the first Ethernet connector of the first controller to determine an operating status of the first controller, by a first controller unit of the first controller. The method also includes comparing a voltage level of a second power connector of a second controller with a voltage level of a second Ethernet connector of the second controller to determine an operating status of the second controller, by a second controller unit of the second controller.

According to one embodiment of the present disclosure, it is possible to charge a low-voltage battery from a high-voltage battery while supplying power to a controller in both directions using the high-voltage battery and the low-voltage battery.

Effects of the present disclosure are not limited to the above-mentioned effects, and other effects that are not mentioned above should be clearly understood by those having ordinary skill in the art from the following description.

### BRIEF DESCRIPTION OF THE DRAWINGS

FIG. 1 is a diagram illustrating the structure of a controller constituting a network according to one embodiment of the present disclosure.

FIG. 2 is a diagram illustrating the structure of a PoDL system of a network according to one embodiment of the present disclosure.

FIG. 3 is a timing chart illustrating a process in which a first controller and a second controller operate according to one embodiment of the present disclosure.

FIG. 4 is a flowchart illustrating an operating method of a PoDL system according to one embodiment of the present disclosure.

FIG. 5 is a block diagram schematically illustrating a computing device to which the present disclosure may be applied.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms, such as first, second, A, B, (a), (b), etc., are used solely to differentiate one component from the other but are not intended to imply or suggest the substances, order, or sequence of the components. Throughout the present disclosure, when a part ‘includes’ or ‘comprises’ a component, the part is meant to further include other components and not to exclude other components unless specifically stated to the contrary. The terms, such as ‘unit’, ‘module’, and the like, refer to one or more units for processing at least one function or operation, which may be implemented by hardware, software, or a combination thereof. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

The following detailed description, together with the accompanying drawings, is intended to illustrate embodiments of the present disclosure and is not intended to represent the only embodiments in which the disclosure may be practiced.

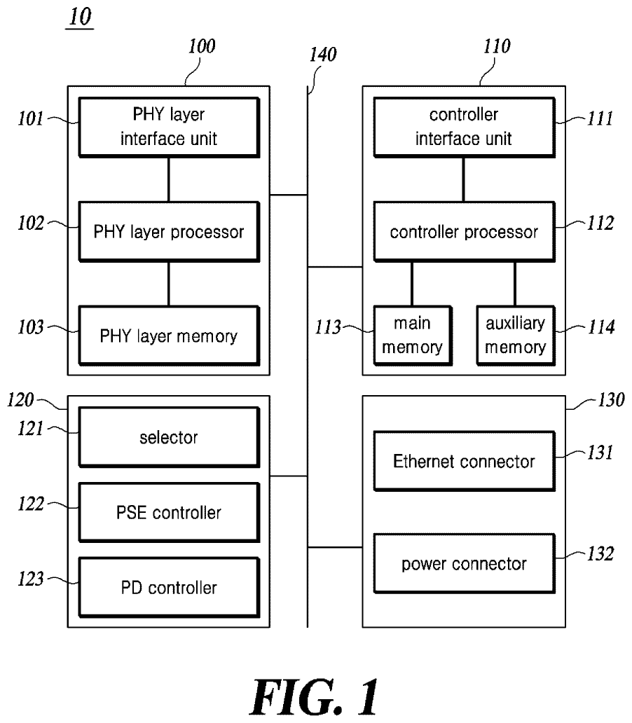

FIG. 1 is a diagram illustrating the structure of a controller constituting a network according to one embodiment of the present disclosure.

Referring to FIG. 1, the controller 10 forming the network may include a physical (PHY) layer unit 100, a controller unit 110, a setting unit 120, and a connector unit 130.

The PHY layer unit 100, the controller unit 110, the setting unit 120, and the connector unit 130 may be connected to each other using a Media Independent Interface (MII) 140. The MII 140 may refer to an interface specified in IEEE 802.3 and may be configured as a data interface and a management interface between units. Instead of the MII 140, one of a RMII (reduced MII), a GMII (gigabit MII), a RGMII (reduced GMII), a SGMII (serial GMII), or a XGMII (10 GMII) may be used. The data interface may include a transmission channel and a receiving channel, and each of the channels may have an independent clock, data, and a control signal. The management interface may comprise a 2-signal interface, one signal for clock, and the other for data.

The PHY layer unit 100 may include a PHY layer interface unit 101, a PHY layer processor 102, a PHY layer memory 103, etc. The configuration of the PHY layer unit 100 is not limited thereto, and the PHY layer unit 100 may be formed in various ways.

The PHY layer interface unit 101 may transmit a signal received from the controller unit 110 to the PHY layer processor 102 and may transmit a signal received from the PHY layer processor 102 to the controller unit 110.

The PHY layer processor 102 may control the operation of each of the PHY layer interface unit 101 and the PHY layer memory 103. The PHY layer processor 102 may perform modulation of a signal to be transmitted or demodulation of a received signal. The PHY layer processor 102 may control the PHY layer memory 103 to input or output a signal.

The PHY layer memory 103 may store the received signal and may output the stored signal according to a request from the PHY layer processor 102.

The controller unit 110 may include a controller interface unit 111, a controller processor 112, a main memory 113, and an auxiliary memory 114. The configuration of the controller unit 110 is not limited thereto, and the controller unit 110 may be formed in various ways. The controller unit 110 may perform the monitoring and control of the PHY layer unit 100, the setting unit 120, and the connector unit 130 using the MII 140.

The controller interface unit 111 may receive a signal from the PHY layer unit 100 (i.e., the PHY layer interface unit 101) or an upper layer, may transmit the received signal to the controller processor 112, and may transmit the received signal from the controller processor 112 to the PHY layer unit 100 or the upper layer.

The controller processor 112 may further include independent memory control logic or integrated memory control logic for controlling the controller interface unit 111, the main memory 113, and the auxiliary memory 114. The memory control logic may be implemented to be included in the main memory 113 and the auxiliary memory 114 or may be implemented to be included in the controller processor 112.

Each of the main memory 113 and the auxiliary memory 114 may store a signal processed by the controller processor 112 and may output the stored signal according to a request from the controller processor 112. The main memory 113 may be a volatile memory (e.g., RAM) that temporarily stores data required for the operation of the controller processor 112. The auxiliary memory 114 may be a non-volatile memory in which an operating system code (e.g., kernel and device driver) and an application program code for performing the function of the controller processor 112 are stored. The non-volatile memory may use a flash memory with fast processing speed, a hard disk drive (HDD), or compact disc-read only memory (CD-ROM) for storing massive data. The controller processor 112 may be generally formed using a logic circuit including at least one processing core. A core of the ARM (Advanced RISC Machines Ltd.) series, a core of the Atom series, etc. may be used as the controller processor 112.

The controller unit 110 may be implemented to include a Medium Access Control (MAC) layer. The PHY layer unit 100 may receive a signal from another controller or may transmit a signal to another controller. The controller unit 110 may control the operation of the PHY layer unit 100 to receive a signal from another controller or transmit a signal to another controller. For example, the controller unit 110 may transmit the operating status of the controller 10 to another controller and may receive the operating status of another controller.

The controller unit 110 may control the operation of the setting unit 120. The controller unit 110 controls the controller 10 to operate as a power sourcing equipment (PSE) when the voltage of a power connector 132 of the controller 10 is greater than or equal to the voltage of an Ethernet connector 131. The controller unit 110 controls the controller 10 to operate as a powered device (PD) when the voltage of the power connector 132 of the controller 10 is less than the voltage of the Ethernet connector 131. The controller unit 110 may control the operation of the setting unit 120 by controlling the operation of a selector 121.

The controller unit 110 may detect the voltage level of the connector unit 130. The controller unit 110 may detect the voltage level of the power connector 132. The controller unit 110 may detect the voltage level of the Ethernet connector 131. The controller unit 110 may compare the voltage level of the Ethernet connector 131 with the voltage level of the power connector 132.

The setting unit 120 includes the selector 121, a PSE controller 122, and a PD controller 123. The PSE controller 122 may detect and authenticate a compatible PD, may determine a power classification signature for the authenticated PD, and may enable the PSE to supply power to the PD. The PSE controller 122 may monitor power and may reduce or eliminate power when power is no longer required or needed.

The PD controller 123 may transmit Power over Data Line (PoDL) information in response to the signal of the PSE controller.

The setting unit 120 may determine whether the controller 10 operates as the PD or operates as the PSE. The setting unit 120 may determine that the controller 10 operates as the PSE by connecting the PSE controller 122 to the Ethernet connector 131. The setting unit 120 may determine that the controller 10 operates as the PD by connecting the PD controller 123 to the Ethernet connector 131. The setting unit 120 may connect the PSE controller 122 or the PD controller 123 to the Ethernet connector 131 by selecting the selector 121. For example, when the selector 121 selects the PSE controller 122, the PSE controller 122 is connected to the Ethernet connector 131. When the selector 121 selects the PD controller 123, the PD controller 123 is connected to the Ethernet connector 131. The selector 121 includes a switch, a multiplexer, and a demultiplexer.

The connector unit 130 includes the Ethernet connector 131 and the power connector 132. A power supply source may be connected to the power connector 132. The power supply source includes a low-voltage battery, a high-voltage battery, and a Low voltage DC-DC Converter (LDC). The controller 10 may be supplied with power from the power supply source connected to the power connector 132. A wire may be connected to the Ethernet connector. The controller 10 may transmit or receive power and data to or from another controller via a wire.

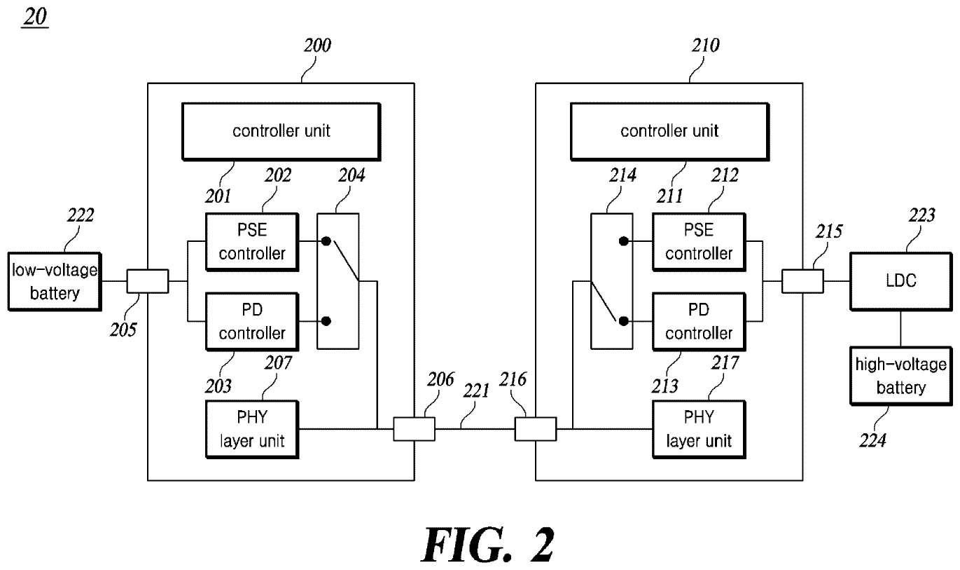

FIG. 2 is a diagram illustrating the structure of a PoDL system of a network according to one embodiment of the present disclosure.

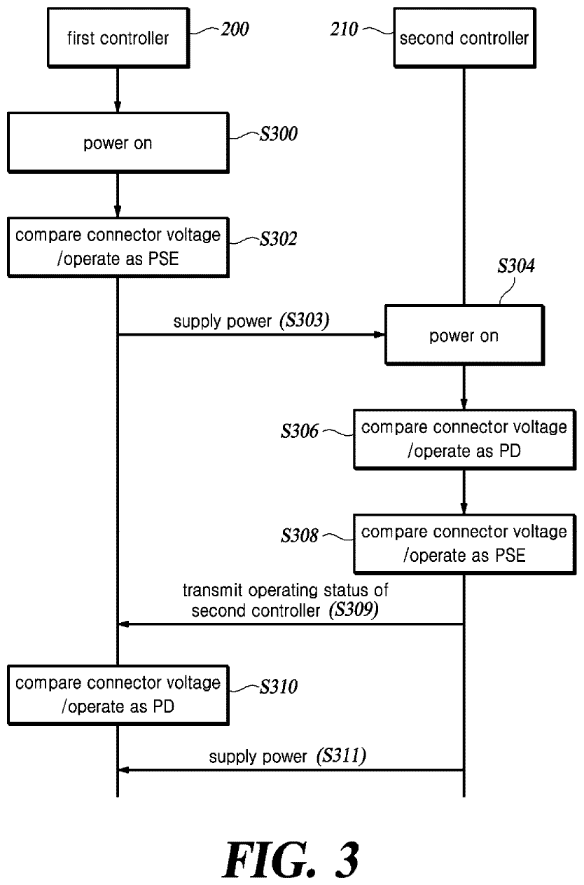

FIG. 3 is a timing chart illustrating a process in which a first controller and a second controller operate according to one embodiment of the present disclosure.

Hereinafter, a method performed by the controller belonging to the network and its corresponding counterpart controller is described.

The PoDL system 20 of the network includes a first controller 200, a second controller 210, a wire 221, a low-voltage battery 222, a high-voltage battery 224, and an LDC 223. The first controller 200 may operate as the PD or PSE. The first controller 200 may be connected to the second controller 210 via the wire 221 (e.g., link segment). The wire 221 connects the first Ethernet connector 206 and the second Ethernet connector 216. The wire 221 may support the IEEE 802.3bu standard.

The LDC 223 is connected to the second Ethernet connector 215 and the high-voltage battery 224 in series. In other words, one side of the LDC 223 is connected to the second power connector 215, while the other side is connected to the high-voltage battery 224.

The first controller 200 includes a first controller unit 201, a first PSE controller 202, a first PD controller 203, a first selector 204, a first power connector 205, a first Ethernet connector 206, and a first PHY layer unit 207. Each configuration of the first controller 200 may be identical or similar to each configuration of the controller 10 described with reference to FIG. 1.

The second controller 210 may operate as the PD or PSE. The second controller 210 includes a second controller unit 211, a second PSE controller 212, a second PD controller 213, a second selector 214, a second power connector 215, a second Ethernet connector 216, and a second PHY layer unit 217. Each configuration of the second controller 210 may be identical or similar to each configuration of the controller 10 described with reference to FIG. 1.

The low-voltage battery 222 may be connected to the first power connector 205 of the first controller 200. The first controller 200 is powered on by receiving power from the low-voltage battery 222 connected to the first power connector 205, at step S300.

The first controller unit 201 compares the voltage level of the first power connector 205 with the voltage level of the first Ethernet connector 206, at step S302. The first power connector 205 is connected to the low-voltage battery 222. Thus, the voltage of the first power connector 205 is greater than or equal to the voltage of the first Ethernet connector 206. The first controller unit 201 controls the first controller 200 to operate as the PSE. The first controller unit 201 controls the first selector 204 to select the first PSE controller 202, so that the first PSE controller 202 is connected to the first Ethernet connector 206 and the first PD controller 203 is in an open state. Thus, the first controller 200 operates as the PSE.

The first controller 200 operating as the PSE may supply power to the second controller 210, at step S303. The first Ethernet connector 206 connected to the first PSE controller 202 is connected via the wire 221 to the second Ethernet connector 216. Thus, the first controller 200 may supply power to the second controller 210 via the wire 221.

The second controller 210 is powered on by receiving power from the first controller 200 via the wire 221, at step S304. The second controller 210, which is supplied with power by the second Ethernet connector 216 connected to the first Ethernet connector 206 via the wire 221, is powered on.

The second controller unit 211 compares the voltage level of the second power connector 215 with the voltage level of the second Ethernet connector 216, at step S306. The second power connector 216 is connected to the first Ethernet connector 206 via the wire 221, the first Ethernet connector 206 is connected to the first PSE controller 202, and the first PSE controller 202 is connected to the low-voltage battery 222. Therefore, the voltage of the second power connector 215 is smaller than the voltage of the second Ethernet connector 216. The second controller unit 211 controls the second controller 210 to operate as the PD. The second controller unit 211 controls the second selector 214 to select the second PD controller 213, so that the second PD controller 213 is connected to the second Ethernet connector 216 and the second PSE controller 212 is in an open state. Thus, the second controller 210 operates as the PD.

The LDC 223 may be connected to the second power connector 215 of the second controller 210. When a device including the PoDL system is powered on (e.g., the ignition of a vehicle is turned on), the LDC 223 converts the voltage of the high-voltage battery 224 connected to the LDC 223 into a low voltage and then outputs the voltage. Thus, the second controller unit 211 may detect the output voltage of the LDC 223 in the second power connector 215.

When the voltage of the second power connector 215 is smaller than the voltage of the second Ethernet connector 216, the second controller 210 controls to maintain the operation as the PD.

When the voltage of the second power connector 215 is greater than or equal to the voltage of the second Ethernet connector 216, the second controller 210 controls to operate as the PSE, at S308. The second controller unit 211 controls the second selector 214 to select the second PSE controller 212, so that the second PSE controller 212 is connected to the second Ethernet connector 216 and the second PD controller 213 is in an open state. Thus, the second controller 210 operates as the PSE. The second controller 210 operating as the PSE may supply power to another controller. Because the second Ethernet connector 216 connected to the second PSE controller 212 may be connected to another Ethernet connector via the wire, the second controller 210 may supply power to another controller.

The second controller unit 211 transmits, via the wire 221, to the first controller unit 201 that the second controller 210 is operating as the PSE, at S309. The second controller unit 211 may transmit the operating status of the second controller 210 to the first controller unit 201. Communication between the first controller unit 201 and the second controller unit 211 may be performed using a Link Layer Discovery Protocol (LLDP).

The first controller unit 201, which receives from the second controller unit 211 that the second controller 210 is operating as the PSE, compares the voltage level of the first power connector 205 with the voltage level of the first Ethernet connector 206, at step S310. The first power connector 205 is connected to the low-voltage battery 222. The first Ethernet connector 206 is connected via the wire 221 to the second Ethernet connector 216. The second Ethernet connector 216 is connected to the second PSE controller 212, and the second PSE controller 212 is connected to the LDC 223. Therefore, the voltage of the first power connector is smaller than the voltage of the first Ethernet connector 206. The first controller unit 201 controls the first controller 200 to operate as the PD. The first controller unit 201 controls the first selector 204 to select the first PD controller 203, so that the first PD controller 203 is connected to the first Ethernet connector 206 and the first PSE controller 202 is in an open state. Thus, the first controller 200 operates as the PD.

The second controller 210 operating as the PSE may supply power via the wire 221 to the first controller 200 operating as the PD, at step S311. Because the first Ethernet connector 206 connected to the first PD controller 203 is connected to the second Ethernet connector 216 connected to the second PSE controller 212 via the wire 221, the second controller 210 may supply power to the first controller 200.

The first controller 200 operating as the PD may supply power to the low-voltage battery 222 connected to the first power connector 205 to charge the low-voltage battery 222.

The PoDL system may charge the low-voltage battery from the high-voltage battery. The PoDL system may supply power from the low-voltage battery and the high-voltage battery (or Low voltage DC-DC Converter (LDC)) to the controller in both directions. For example, referring to FIG. 3, the first controller 200, which receives power from the low-voltage battery 222, may supply power to the second controller 210. The second controller 210, which receives power from the high-voltage battery 224 (or LDC 223), may supply power to the first controller 200.

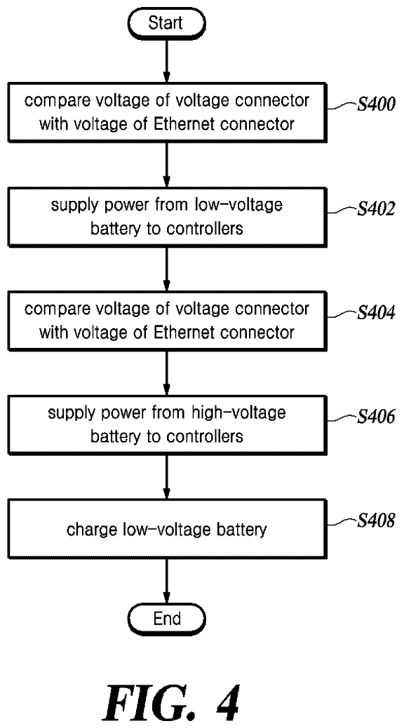

FIG. 4 is a flowchart illustrating an operating method of a PoDL system according to one embodiment of the present disclosure. The method shown in FIG. 4 may be implemented by being executed by the PoDL system 20.

The first controller of the PoDL system is powered on by receiving power from the low-voltage battery connected to the first power connector.

The first controller unit compares the voltage level of the first power connector with the voltage level of the first Ethernet connector to determine the operating status of the first controller, at step S400. Because the device including the PoDL system is not powered on (e.g., the ignition of the vehicle is off), the voltage of the first power connector connected to the low-voltage battery is greater than or equal to the voltage of the first Ethernet connector. Therefore, the first controller unit controls the first PSE controller to be connected to the first Ethernet connector and controls the first PD controller to be in an open state, so that the first controller operates as the PSE.

The first controller operating as the PSE may supply power from the low-voltage battery through the wire to another controller, at step S402. Because the first Ethernet connector connected to the first PSE controller is connected via the wire to the second Ethernet connector, the first controller may supply power to the second controller. The second controller receiving power is powered on.

The second controller unit compares the voltage level of the second power connector with the voltage level of the second Ethernet connector to determine the operating status of the second controller, at step S404. Because the device including the PoDL system is not powered on (e.g., the ignition of the vehicle is off), the voltage of the second power connector is smaller than the voltage of the second Ethernet connector connected to the first Ethernet connector. Therefore, the second controller unit controls the second PD controller to be connected to the second Ethernet connector and controls the second PSE controller to be in an open state, so that the second controller operates as the PD.

When the device including the PoDL system is powered on (e.g., the ignition of the vehicle is turned on), the LDC converts the voltage of the high-voltage battery connected to the LDC into a low voltage and then outputs the voltage. When the voltage of the second power connector connected to the output terminal of the LDC is greater than the voltage of the second Ethernet connector, the second controller unit controls the second PSE controller to be connected to the second Ethernet connector and controls the second PD controller to be in an open state, so that the second controller operates as the PSE.

The second controller operating as the PSE may supply power from the high-voltage battery through the wire to another controller, at step S406. In order for the second controller operating as the PSE to supply power to the first controller, the first controller should operate as the PD. The second controller unit transmits to the first controller unit via the wire that the second controller is operating as the PSE. The first controller unit, which receives information that the second controller is operating as the PSE, compares the voltage level of the first power connector with the voltage level of the first Ethernet connector. Because the device including the PoDL system is powered on (e.g., the ignition of the vehicle is on), the voltage of the first power connector connected to the low-voltage battery is smaller than the voltage of the first Ethernet connector connected to the second controller receiving power from the high-voltage battery. Therefore, the first controller unit controls the first PD controller to be connected to the first Ethernet connector and controls the first PSE controller to be in an open state, so that the first controller operates as the PD. The first controller operating as the PD may be supplied with power from the second controller via the wire.

The first controller operating as the PD may receive power from the second controller and may supply power to the low-voltage battery connected to the first power connector. Thus, the low-voltage battery may be charged, at step S408.

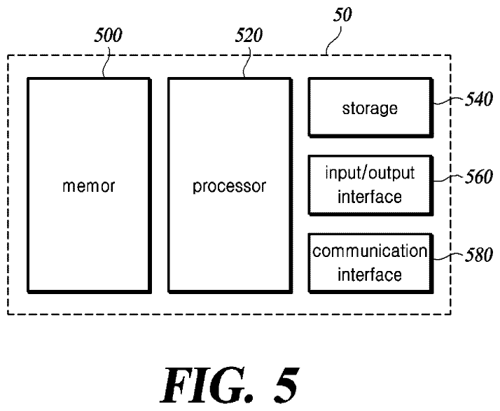

FIG. 5 is a block diagram schematically illustrating a computing device to which the present disclosure may be applied.

Referring to FIG. 5, the computing device 50 may include some or all of a memory 500, a processor 520, a storage 540, an input/output interface 560, or a communication interface 580. The computing device 50 may structurally and/or functionally include part of the PoDL system 20 illustrated in FIG. 2. The computing device 50 may be a stationary computing device such as a desktop computer, a server, and/or an intelligent computer as well as a mobile computing device such as a smart phone or a laptop computer.

The memory 500 may store a program that causes the processor 520 to perform method(s) according to the present disclosure. For example, the program may include a plurality of instructions executable by the processor 520, and the above-described method(s) may be performed by executing the plurality of instructions by the processor 520.

The memory 500 may be a single memory or multiple memories. Information required for image fusion may be stored in the single memory or be separately stored in the multiple memories. When the memory 500 comprises multiple memories, the multiple memories may be physically separated. The memory 500 may include at least one of a volatile memory or a non-volatile memory. The volatile memory includes a Static Random Access Memory (SRAM) or a Dynamic Random Access Memory (DRAM), and the non-volatile memory includes a flash memory.

The processor 520 may include at least one core capable of executing at least one instruction. The processor 520 may execute instructions stored in the memory 500. The processor 520 may be a single processor or multiple processors.

The storage 540 maintains stored data even when power supplied to the computing device 50 is cut off. For example, the storage 540 may include the non-volatile memory or may include storage media such as magnetic tape, optical disks, or magnetic disks.

A program stored in the storage 540 may be loaded into the memory 500 before being executed by the processor 520. The storage 540 may store a file written in a programming language, and a program generated from the file by a compiler or the like may be loaded into the memory 500. The storage 540 may store data to be processed by the processor 520 and/or data processed by the processor 520.

The input/output interface 560 may include an input device, such as a keyboard, a mouse, a touch interface, a microphone and/or a camera, and may include an output device, such as a display and/or a speaker. A user may trigger the execution of a program by the processor 520, may input a set value, and/or may check the processing result of the program through the input/output interface 560.

The communication interface 580 provides access to an external device. For example, the computing device 50 may communicate with persons concerned and other devices via the communication interface 580. Each component of the device or method according to the present disclosure may be implemented as hardware or software, or as a combination of hardware and software. In addition, the function of each component may be implemented in software, and a microprocessor may be implemented to execute the function of the software corresponding to each component.

Each element of the apparatus or method can be implemented in hardware, software, or a combination of hardware and software. The functions of the respective elements may be implemented in software, and a microprocessor can be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

A computer-readable recording medium includes any type of recording device that stores data that can be read by a computer system. Such a computer-readable recording medium may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium may also be distributed across a networked computer system, such that the computer-readable code is stored and executed in a distributed manner.

Although operations are illustrated in the flowcharts/timing charts in the present disclosure as being sequentially performed, this is merely a description of the technical idea of embodiments of the present disclosure. In other words, those having ordinary skill in the art to which the present disclosure pertains may appreciate that various modifications and changes can be made without departing from essential features of embodiments of the present disclosure. In other words, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed present disclosure. Therefore, the embodiments of the present disclosure have been described for the sake of brevity and clarity. The scope of the technical idea of the present disclosure is not limited by the illustrations. Accordingly, one having ordinary skill in the art should understand that the scope of the claimed present disclosure is not to be limited by the above explicitly described embodiments but by the claims and equivalents thereof.

What is claimed is:

1. A Power over Data Line (PoDL) system for supplying power, the PoDL system comprising:
a high-voltage battery;
a first controller comprising a first controller unit, a first power sourcing equipment (PSE) controller, a first powered device (PD) controller, a first power connector, a first Ethernet connector, and a first selector;
a second controller comprising a second controller unit, a second PSE controller, a second PD controller, a second power connector, a second Ethernet connector, and a second selector;
a low-voltage battery connected to the first power connector; and
a low voltage DC-DC converter (LDC) connected to the second power connector and the high-voltage battery in series,
wherein the first Ethernet connector and the second Ethernet connector are connected to each other via a wire.

2. The PoDL system of claim 1,
wherein the first controller unit is configured to compare a voltage level of the first power connector with a voltage level of the first Ethernet connector, and
wherein the second controller unit is configured to compare a voltage level of the second power connector with a voltage level of the second Ethernet connector.

3. The PoDL system of claim 2,
wherein the first controller unit is configured to:
control the first controller to operate as a PSE when the voltage level of the first power connector is greater than or equal to the voltage level of the first Ethernet connector; and
control the first controller to operate as a PD when the voltage level of the first power connector is smaller than the voltage level of the first Ethernet connector, and
wherein the second controller unit is configured to:
control the second controller to operate as a PSE when the voltage level of the second power connector is greater than or equal to the voltage level of the second Ethernet connector; and
control the second controller to operate as a PD when the voltage level of the second power connector is smaller than the voltage level of the second Ethernet connector.

4. The PoDL system of claim 3,
wherein the first controller unit is configured to:
connect the first PSE controller and the first Ethernet connector to control the first controller to operate as the PSE; and
connect the first PD controller and the first Ethernet connector to control the first controller as the PD, and
wherein the second controller unit is configured to:
connect the second PSE controller and the second Ethernet connector to control the second controller to operate as the PSE; and
connect the second PD controller and the second Ethernet connector to control the second controller as the PD.

5. The PoDL system of claim 4,
wherein the first controller unit is configured to:
connect the first PSE controller and the first Ethernet connector by controlling the first selector to select the first PSE controller; and
connect the first PD controller and the first Ethernet connector by controlling the first selector to select the first PD controller, and
wherein the second controller unit is configured to:
connect the second PSE controller and the second Ethernet connector by controlling the second selector to select the second PSE controller; and
connect the second PD controller and the second Ethernet connector by controlling the second selector to select the second PD controller.

6. The PoDL system of claim 5,
wherein the first PD controller is configured to be opened when the first selector selects the first PSE controller,
wherein the first PSE controller is configured to be opened when the first selector selects the first PD controller,
wherein the second PD controller is configured to be opened when the second selector selects the second PSE controller, and
wherein the second PSE controller is configured to be opened when the second selector selects the second PD controller.

7. The PoDL system of claim 6, wherein each of the first selector and the second selector comprises a switch, a multiplexer, and a demultiplexer.

8. The PoDL system of claim 7,
wherein the second controller unit is configured to transmit an operating status of the second controller to the first controller unit via the wire, and
wherein the first controller unit is configured to receive the operating status of the second controller from the second controller unit via the wire.

9. The PoDL system of claim 8, wherein communication between the first controller unit and the second controller unit is performed using a Link Layer Discovery Protocol (LLDP).

10. The PoDL system of claim 9, wherein the first controller operating as the PSE is configured to receive power from the low-voltage battery and supply power to the second controller operating as the PD.

11. The PoDL system of claim 9, wherein the second controller operating as the PSE is configured to receive power from the high-voltage battery and supply power to the first controller operating as the PD.

12. The PoDL system of claim 11, wherein the low-voltage battery is charged by receiving power from the first controller operating as the PD.

13. A method of operating a PoDL system, the method comprising:
comparing a voltage level of a first power connector of a first controller with a voltage level of a first Ethernet connector of the first controller to determine an operating status of the first controller, by a first controller unit of the first controller; and
comparing a voltage level of a second power connector of a second controller with a voltage level of a second Ethernet connector of the second controller to determine an operating status of the second controller, by a second controller unit of the second controller.

14. The method of claim 13, further comprising:
transmitting the operating status of the second controller to the first controller unit via a wire, by the second controller unit; and
receiving the operating status of the second controller from the second controller unit via the wire, by the first controller unit.
